(19) United States
(12) Patent Application Publication
(10) Pub. No.: US 2006/0196349 A1
(43) Pub. Date: Sep. 7, 2006

(54) Controlling instrument

(76) Inventor: Bruno Coissac, Asnieres/Seine (FR)

Correspondence Address: Coissac, Bruno, 258 Avenue D'Argenteuil, Asnieres Sur Seine, 92600, FR

(21) Appl. No.: 10/552,022

(22) PCT Filed: Apr. 17, 2003
(86) PCT No.: PCT/FR03/01230

§ 371 Date: Oct. 3, 2005

(51) Int. Cl. G10H 3/14

(52) U.S. Cl. 84/734

(57) ABSTRACT

The invention relates to a controlling instrument which enables a mobile user to trigger electronic, electrical, acoustic, visual and mechanical events. In the musical domain, said instrument enable two handed playing which, depending on the variants, ranges over more or less five simultaneous octaves, whith further modulation possibilities without the addition of a pedal or a mouthpiece.

The inventive instrument also comprises, as main characteristics, a prehension bar (1) that can be flexible and digital controls (3) which are adjacently arranged thereon, said flexible bar (1) controlling a sensor (5). The inventive device is especially suitable for shows and indutry.

This invention concerns a device acting as an interface between the user and a system or systems for generation, management, transmission and reception of electronic and computerised signals or languages which enable the triggering, control and stopping of electronic, electrical and mechanical events such as, to give a non-limitative example, those which concern the triggering, control and stopping of audible, visual and mechanical events in the artistic and performing arts fields.

Keyboards with pianoforte type ergonomics are very widely used around the world to trigger and control synthesisers and samplers and can also be used to control slaved spotlights, their accessories and certain remotely controlled stage machines.

When placed on a support, such keyboards oblige the user to be close to them in order to play them, either in front of, behind or alongside them. When the user wishes to move over a greater distance while still playing, he can carry on a shoulder strap a light pianoforte type keyboard which does not allow playing with both hands on five simultaneous octaves or more as with a conventional pianoforte type keyboard placed on a support. If the pianoforte type keyboard carried on a shoulder strap allows playing with both hands on five simultaneous octaves, the shape and weight constraints it imposes are restrictive as to the time for which it can be used in a standing position and when moving.

The device according to this invention, although not presenting the ergonomics of a pianoforte type keyboard, enables the user to trigger, control and stop electronic, electrical and mechanical events and, according to a first characteristic, to be mobile during use, without any major shape and weight constraint, in the same way, to give a non-limitative example, as a guitarist carrying his instrument on a shoulder strap, while at the same time retaining the possibility of playing with both hands on five simultaneous octaves or on more or less five simultaneous octaves, depending on the variants required to be produced of the controlling instrument concerned by this invention, and, according to second characteristic, offers, at the same time as this playing with two hands, additional control possibilities compared to conventional pianoforte type keyboards placed on a support or compared to those carried on a shoulder strap, without the addition of a pedal or contactor which might be operated with the foot or the addition of a control which might be operated with the mouth.

This invention concerns a device which, according to a first characteristic, is in the shape of a cylindrical or non-cylindrical stick or bar on all or part of its surface, usable with one or more hands without the help of the mouth and which, by pressure, brushing or nearing of the dedicated control zones, juxtaposed along the said stick or the said bar on all or part of its surface, allows the user to trigger, control and stop electronic, electrical and mechanical events by way of contactors, switches, sensors or controls dependent on these “control” zones or partly or wholly composing these “control” zones.

The shape and the layout of these “control” zones and the shape of the controlling instrument concerned by this invention allow the user's fingertips to access these “control” zones with each hand independently oriented with the palm towards the user or the back towards the user without any particular effort or obligation to touch the controlling instrument concerned by this invention with the forearm or the arm.

According to specific modes of production, the shape and the layout of these “control” zones may be designed to allow the finger, in a non-restrictive way, when using them, to move from one of these “control” zones to another rapidly as by sliding without encountering any obstacle or resistance which might injure it or hinder it.

The layout of these “control” zones allows in a non-restrictive way the user who so wishes to find the order of the keys offered by a conventional pianoforte type keyboard. The layout of these “control” zones allows the user in a non-restrictive way, during musical use, to find the order of the notes offered by a conventional pianoforte type keyboard, namely low to high from left to right, and, in a non-restrictive way, if the systems connected to the device according to this invention authorise it, to play in polyphony. The device according to this invention allows the user, in a non-restrictive way, if the systems connected to the device according to this invention authorise it, to trigger, control and stop several electronic, electrical and mechanical events simultaneously.

The number, size and shape of the “control” zones are also defined by the variants of the controlling instrument concerned by this invention which are required to be produced. To give a non-limitative example, sixty-one control zones eighteen millimetres wide, each comprising a strain gauge sensing the surface finger pressure, can be positioned in rings juxtaposed along the said stick or bar.

This invention concerns a device which, according to a second characteristic, by undergoing one or more bending or twisting stresses, enables the user to trigger, control and stop electronic, electrical and mechanical events by way of contactors, switches, sensors or controls dependent on this or these bending or twisting stresses. The stopping of a bending or twisting stress may be parameterised as an instruction.

To give a non-limitative example, during musical use, the control or controls dependent on one or more bending or twisting stresses may be used to trigger, control and stop modulations on the tone, the height and the envelope of the sounds or notes triggered by the “control” zones described according to the first characteristic.

To allow, according to the second characteristic, the controlling instrument concerned by this intervention to be subjected to one or more bending or twisting stresses and return to its initial position or shape after the stopping of a bending or twisting stress, within the limits of an appropriate use, several modes of production are possible.

These specific modes of production may use one or more springs and/or any material, matter equipment or combinations of these which can produce an effect similar or comparable to that of a spring, namely an effect of flexibility and return to the initial position or shape following the stopping of the application of a bending or twisting stress.

To give a non-limitative example, a firm spring may be placed inside, from one end to the other, the controlling instrument concerned by this invention.

The possibilities of control by bending or twisting stress offered by the second characteristic may be, in a non-restrictive way, used at the same time as the use of the “control” zones described according to the first characteristic.

According to specific modes of production:

to complement and favour the first and second characteristics, the stick or the bar formed for or by the juxtaposition of the “control” zones may comprise one or more parts external to these “control” zones, without any effect on these zones, to allow, for example, the pressing of the thumb or the pressing of the controlling instrument concerned by this invention on a part or parts of the user's body.

to complement and favour the first and second characteristics, the controlling instrument concerned by this invention can be carried on a shoulder strap or attached to the user's body by any flexible or solid means.

each of the contactors, switches, sensors and controls of the controlling instrument concerned by this invention may be partly or wholly sensitive or insensitive to the intensity and/or the velocity of the action which is applied to it by the user.

each of the controls and “control” zones of the controlling instrument concerned by this invention may be indicated by one or more characters, signs or symbols, or protruding or recessed or luminous markings.

the stick (or bar) formed for or by the juxtaposition of the “control” zones may be made straight, curved or bent at an angle and may be covered partly or wholly by a flexible material which may be impermeable.

parts may be placed at the ends of the length of the stick (or bar) or formed for or by the juxtaposition of the “control” zones or incorporated in it or linked to it or installed separately.

These parts may be designed to:

accommodate contactors, switches, sensors, potentiometers, additional finger controls and screens enabling the user to control a system or systems, embedded or otherwise, serving to configure the controlling instrument concerned by this invention, to generate and apply modulations, to use memories, to start the playing and recording of sequences, and to trigger, control and stop electronic, electrical and mechanical events.

accommodate and house the electrical and electronic system or systems necessary for the recognition, management and encoding of each of the controls and functions of the controlling instrument concerned by this invention.

accommodate and house the electrical and electronic system or systems necessary for the generation, management, transmission and reception of the electronic or computerised protocols and languages chosen for the communication between the controlling instrument concerned by this invention and a system or systems, embedded or otherwise, generating electronic, electrical, audible, visual and mechanical events.

accommodate and house a system or systems generating audible, visual and mechanical events linked directly to the control recognition and management system of the controlling instrument concerned by this invention.

accommodate and house the necessary electrical power supply.

accommodate the necessary wiring and connectors.

According to specific modes of production, the controlling instrument concerned by this invention may be linked to a wireless system, incorporated or otherwise, for transmission and/or reception of data and/or signals enabling the triggering, control and stopping of electronic, electrical, audible, visual and mechanical events.

According to specific modes of production:

the device according to the invention comprises a handling bar which may be flexible, the length of which is constituted by the juxtaposition of finger controls.

the finger controls juxtaposed on the length of the handling bar may form a surface which extends from one edge to the other of the width of the said bar.

the finger controls juxtaposed on the length of the handling bar may form a surface which is curved in the widthways direction.

the juxtaposition of these finger controls may compose a flexible length, and the device according to the invention may comprise at least one sensor for the bending.

the device according to the invention may comprise one or more additional finger controls, the operation of which by the user replaces the triggering of the finger controls juxtaposed on the length of the handling bar, which are then used to designate the events to be triggered.

this or these additional finger controls may be made of a flexible material and comprise a sensor for the bending; they may be bent by a finger or by an accessory held by a finger or fingers.

five additional finger controls of this type may be placed alongside each other in parallel to the handling bar on a support attached at the end of this bar.

To give a non-limitative example, during musical use, these five additional finger controls, which will be designated for easier understanding as CS1, CS2, CS3, CS4 and CS5, can be parameterised to be used as follows:

It is considered that the finger controls juxtaposed on the length of the handling bar can each be allocated, from the first to the last respectively in succession, to each note of a series of notes progressing from low to high.

A dedicated contactor may be provided to configure the finger control management electronics in such a way that the triggering of the notes allocated to the finger controls juxtaposed on the length of the handling bar is carried out by controls CS1 to CS5; these notes are then designated by the use of the finger controls juxtaposed on the length of the handling bar and triggered by controls CS1 to CS5.

When only one of the finger controls juxtaposed on the length of the handling bar is used, the note designated by this control is triggered by controls CS1, CS2, CS3, CS4 and CS5.

When two of the finger controls juxtaposed on the length of the handling bar are used at the same time, control CS1 triggers the lower of the two notes designated, and CS2, CS3, CS4 and CS5 trigger the higher of the two notes designated.

When three of the finger controls juxtaposed on the length of the handling bar are used at the same time, control CS1 triggers the lowest of the three notes designated, CS2 triggers the designated note which is immediately higher than that triggered by CS1, and controls CS3, CS4 and CS5 trigger the highest of the three notes designated.

When four of the finger controls juxtaposed on the length of the handling bar are used at the same time, control CS1 triggers the lowest of the four notes designated, CS2 triggers the designated note which is immediately higher than that triggered by CS1, control CS3 triggers the designated note which is immediately higher than that triggered by CS2, and controls CS4 and CS5 trigger the highest of the four notes designated.

When five of the finger controls juxtaposed on the length of the handling bar are used at the same time, control CS1 triggers the lowest of the five notes designated, CS2 triggers the designated note which is immediately higher than that triggered by CS1, control CS3 triggers the designated note which is immediately higher than that triggered by CS2, control CS4 triggers the designated note which is immediately higher than that triggered by CS3, and control CS5 triggers the highest of the five notes designated.

The appended drawings illustrate the invention:

FIG. 1 represents the device according to the invention by a view of a fraction of the handling bar, an interior transparent view from T to T′.

FIG. 2 represents the device according to the invention by a cross-sectional view of the handling bar.

FIG. 3 represents the device of the invention according to a version including the additional finger controls called CS.

Finger 4 represents a variant of the handling bar by a cross-sectional view of it.

In reference to these drawings, the device comprises a flexible handling bar (1) on which finger controls are juxtaposed (3).

According to the modes of production illustrated by FIGS. 1, 2 and 3, the device comprises a flexible plastic tube (2) 1119 millimetres long with an external diameter of 50 mm and a crown thickness of 2 mm.

Sixty one stress gauge variable resistors sensing the surface pressure (3), 17 mm wide and 115 mm long, are arched lengthways, secured in such a way as to fit around the outer curve of the tube (2) and positioned along this tube at intervals of one millimetre; care should be taken to leave 11 mm free at each end of the tube (2).

Grooves between the variable resistors (3) are made on the circumference of the tube (2).

5 millimetres before each end of the tube (2), eight holes (7) with a diameter of 3 mm are made at regular intervals on the circumference of the tube (2), giving sixteen holes in all.

A metal spring (4) 1095 millimetres long, with an external diameter of 45 millimetres and a wire diameter of 4 millimetres, the spirals of which are spaced 10 mm from each other, is placed inside the tube (2).

The last spiral of each end of the spring (4) closes on itself in such a way that the wire of the spring (4) ends with two parallel circles.

Twelve bending sensor stress gauge variable resistors (5) are distributed in three groups of four inside the spring (4).

The first group is placed at the middle of the length of the spring (4), and the other two each at an equal distance between each end and the middle of the length of the spring (4).

The four bending sensor stress gauge variable resistors (5) of each group are distributed evenly on the crown of the ring (4) on the inside between two spirals and attached to these spirals in such a way that the resistance value of at least one of these resistors (5) is modified when two respective parts of these two spirals move apart from each other whatever the orientation of the bending applied to the handling bar (1).

Care should be taken to insulate the spring (4) electrically from the conductive parts of these bending sensor variable resistors (5).

Fine holes or fine notches may be made on the spirals of the spring (4) to facilitate the attachment of these bending sensors (5) to the spirals of the spring (4) and avoid rubbing of these bending sensors (5) against the inside of the tube (2).

Two metal cylinders with an external diameter of 46 millimetres, a crown thickness of 4 millimetres and a height of 10 millimetres each have eight threaded holes to accommodate 3 mm screws, at mid-height, evenly distributed around their circumference,.

Two plastic washers with a thickness of 2 millimetres, an external diameter of 46 millimetres and an internal diameter of 26 millimetres, are each placed against each end of the spring (4) inside the tube (2).

Each of the two metal cylinders is placed at each end of the tube (2), inside the tube against each plastic washer, in such a way that the threaded holes of these cylinders correspond to the holes (7) made on the circumference of the tube (2).

A rigid cylindrical part (8) closed at one end, which may be made of PVC, with an external diameter of 54 millimetres, a crown thickness of 2 millimetres, an internal diameter of 50 millimetres and a height of 100 millimetres is perforated eight times 5 millimetres before its open end by holes with a diameter of 3 millimetres evenly distributed around its circumference.

The open end of this part (8) surrounds the end of the tube (2) over a distance of 10 millimetres in such a way that the eight holes with a diameter of 3 mm in the end part (8) correspond to the eight holes (7) in one end of the tube (2) and to the eight threaded holes of one of the two metal cylinders placed at one end of the tube (2), inside the tube.

Eight 3 mm screws pass through the holes in the end part (8) and the holes (7) in one end of the tube (2) and are screwed from the outside in the threaded holes in the metal cylinder.

According to the mode of production illustrated by FIG. 3, the part (9) supporting the controls known as CS is added and attached to the end part (8) or the two are made cast together in a single part.

The controls known as CS are each constituted by a metal strip 45 millimetres long, 4 millimetres wide and of low thickness (less than one millimetre) sheathed with flexible plastic.

These strips (CS) are tautened and attached to the support (9) in such a way that when they are subjected to an upward bending stress, i.e. towards the handling bar (1), or a downward bending stress, the resistance value of at least one bending sensor stress gauge variable resistor (10) is modified.

These variable resistors (10) are each attached on one side to the support (9) and on the other side to a strip (CS).

The thin cables which link the sixty-one surface pressure sensors (3) to their analogue-to-digital conversion circuit pass follow a cable path (6) passing along the tube (2) and covered by flexible plastic.

These cables join the inside of the end part (8) through a hole made in this end part.

The thin cables which link the twelve bending sensors (5) of the spring (4) to their analogue-to-digital conversion circuit pass through the inside of the spring (4) and join the inside of the end part (8) through its open end.

The thin cables which link the bending sensors (10) of the strips (CS) to their analogue-to-digital conversion circuit pass through the hollow interior of the support part (9) and join the inside of the end part (8) through an opening made between the end part (8) and the support part (9).

The circuits for analogue-to-digital conversion, multiplexing/demultiplexing, logic gates, management and serial transmission of the status, address and value bytes in MIDI format (for example), together with an electrical power supply , which may use a 9-volt battery, regulated at 5 volts, and protected by capacitors and a diode, are housed in the end part (8).

If a more complete version is required to be produced, for example with a sequencer, screen, memories and other functions authorised by a standard such as MIDI, and if the interior space of the end part (8) is not sufficient, it is possible to attach in the same way to the other end of the tube (2) a part similar to the end part (8), the wiring passing inside the spring (4).

If the end part (8) is sufficient, or if it is chosen to produce it with larger dimensions, the tube (2) is closed at its other end by a cylindrical cap with an internal diameter of 50 mm and an internal height of 10 millimetres, with eight holes evenly distributed around its circumference and attached to the tube (2) in the same way as the end part (8).

On the circumference of the end part (8), openings are made which are designed to maintain at the surface the On/Off and channel selection controls and other configuration functions, notably for the controls known as CS.

At the closed end of the end part (8) an opening is made to install a 180° five-pin DIN serial connection (11) for the MIDI standard.

A means of attachment for a carrying strap (12) is attached to the end part (8).

A second means of attachment for a carrying strap (12) is attached to the part which closes the other end of the tube (2), second end part (8) or cap.

According to an unillustrated variant, the bending sensor stress gauge variable resistors (5) installed between two spirals of the spring (4) are replaced by stress gauge variable resistors sensing the surface pressure, glued on shims attached to one of the two spirals, the resistance value of which is modified when a part of the other spiral presses against it.

It should be noted that the strips (CS) do not need to enter into vibration to be active.

The device according to the inventions is intended for the triggering and control of electronic, electrical, audible, visual and mechanical events and particularly to be used as a musical instrument with a data transmission standard such as MIDI.

1. Device which can be carried during use, acting as an interface between the user and a system or systems for generation, management, transmission and reception of electronic and computerised signals or languages which enable the triggering, control and stopping of electronic, electrical, audible, visual and mechanical events, a device characterised by the fact that it comprises a handling bar (1) on which juxtaposed finger controls (3) form a surface which extends from one edge to the other of the width of the said handling bar (1).

2. Device acting as an interface between the user and a system or systems for generation, management, transmission and reception of electronic and computerised signals or languages which enable the triggering, control and stopping of electronic, electrical, audible, visual and mechanical events, a device characterised by the fact that it comprises a flexible handling bar (1) on which finger controls (3) are juxtaposed and by the fact that it comprises a sensor (5) slaved to the bending of the said handling bar (1).

3. Device according to one of the previous claims characterized by the fact that it comprises an additional finger control (CS), the operation of which by the user replaces the triggering of the finger controls. (3) juxtaposed on the length of the handling bar (1). These finger controls (3) are then used to designate the events to be triggered.

4. Device according to any one of the previous claims characterised by the fact that it comprises at one end of the handling bar (1) a part (8) accommodating and housing the additional finger controls, together with the electrical and electronic systems and the connectors necessary for its functioning and its electrical power supply.

5. Device according to any one of the previous claims characterised by the fact that it comprises at one end of the handling bar (1) a part (8) accommodating and housing the additional controls (CS).

6. Device according to claim 2 characterised by the fact that the flexible handling bar (1) comprises a spring (4) which enables the flexible handling bar (1) to return to its initial position or shape when a bending or twisting stress ceases to be applied.
